(19) United States
(12) Patent Application Publication
(10) Pub. No.: US 2005/0020159 A1
(43) Pub. Date: Jan. 27, 2005

(54) Hydroentangled continuous filament nonwoven fabric and the articles thereof

(76) Inventor: Jerry Zucker, Charleston, SC (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 10/819,034

(22) Filed: Apr. 6, 2004

Related U.S. Application Data
(60) Provisional application No. 60/462,053, filed on Apr. 11, 2003.

(51) Int. Cl. B32B 9/00; B32B 5/26; D04H 5/02; D04H 18/00

(52) U.S. Cl. 442/59; 442/408; 28/107

(57) ABSTRACT

The present invention relates to a method of forming a nonwoven fabric, and more specifically to a nonwoven fabric comprised of hydroentangled continuously extruded, essentially endless thermoplastic polymer nano-denier filaments. The polymeric nano-denier filaments can be provided in the form of one or more precursor webs, or the process can be practiced in-line process. Fabrics embodying the present invention may comprise laminations of differing polymeric filaments, such as filaments exhibiting significantly differing bonding temperatures.

### TECHNICAL FIELD

The present invention relates generally to a method of forming a nonwoven fabric, and more specifically to a nonwoven fabric comprised of hydroentangled continuously extruded, essentially endless thermoplastic polymer nano-denier filaments. The polymeric nano-denier filaments can be provided in the form of one or more precursor webs, or the process can be practiced in-line process. Fabrics embodying the present invention may comprise dissimilar polymers of differing thermal compatibility, such as polypropylene and polyester. Additionally, fabrics having relatively high basis weights can be formed from a plurality of nano-denier precursor webs.

### BACKGROUND OF THE INVENTION

Nonwoven fabrics are used in a wide variety of applications, where the engineered qualities of the fabrics can be advantageously employed. These types of fabrics differ from traditional woven or knitted fabrics in that the fibers or filaments of the fabric are integrated into a coherent web without traditional textile processes. Entanglement of the fibers or filaments of the fabric provide the fabric with the desired integrity, with the selected entanglement process permitting fabrics to be patterned to achieve desired aesthetics, and physical characteristics.

Various prior art patents disclose nonwoven fabrics manufactured by application of a hydroentangling processes. U.S. Pat. No. 3,485,706, to Evans, hereby incorporated by reference, discloses a hydroentanglement process for manufacture of nonwoven fabrics. Hydroentanglement entails the application of high-pressure water jets to webs of fibers or filaments, whereby the fibers or filaments are rearranged under the influence of water impingement. The web is typically positioned on a support surface as it is subjected to impingement by the water jets, whereby the fibers or filaments of the web become entangled, thus creating a fabric with coherency and integrity.

As is known in the art, the formation of continuous filaments entails extrusion, or “spinning”, essentially endless thermoplastic polymeric filaments, with the resultant filaments cooled and drawn, or attenuated, as they are collected. The continuous, or essentially endless, filaments may be directly extruded onto carrier substrate or bonded to facilitate off-line formation, with the process of the subject invention contemplating that such filamentary material be employed as the precursor web.

Hydroentanglement of continuous filaments are known and demonstrated in U.S. Pat. No. 6,321,425 to Putnam, et al, herein incorporated by reference. It has been contemplated that the hydroentanglement of nano-denier continuous filaments would constitute at least a 20% improvement in softness and at least a 20% improvement in strength over conventional fine denier fabrics comprising 1.0 micron filaments. The fabric of the present invention exhibits an improvement in softness, strength, uniformity, and barrier performance, due to an increase in the number of filaments per unit of fabric.

### SUMMARY OF THE INVENTION

The present invention relates to a method of forming a nonwoven fabric, and more specifically to a nonwoven fabric comprised of hydroentangled continuously extruded, essentially endless thermoplastic polymer nano-denier filaments. The polymeric nano-denier filaments can be provided in the form of one or more precursor webs, or the process can be practiced in-line process. Fabrics embodying the present invention may comprise laminations of differing polymeric filaments, such as filaments exhibiting significantly differing bonding temperatures. Additionally, fabrics having relatively high basis weights can be formed from a plurality of nano-denier precursor webs.

It is in the purview of he invention that the average fiber diameter of the nano-denier filament is in the range of less than or equal to 1000 nanometer, and preferably less than or equal to 500 nanometers. The nano-denier fabric is comprised of a greater number of filaments and a smaller average pore size per unit area. It is contemplated that the hydroentanglement of such a fabric will result in a softer nonwoven fabric with better uniformity, The thermoplastic polymers of the nano-denier continuous filaments are chosen from the group consisting of polyolefins, polyamides, and polyesters, wherein the polyolefins are chosen from the group consisting of polypropylene, polyethylene, and combinations thereof. It is within the purview of the present invention that the nano-denier, continuous filament layer or layers may comprise either the same or different thermoplastic polymers. Further, the nano-denier continuous filament layer or layers may comprise homogeneous, bi-component, and/or multi-component profiles, as well as, performance modifying additives, and the blends thereof. Further still, the continuous filaments may comprise dissimilar polymers of differing thermal compatibility, such as polypropylene and polyester.

The present invention is directed to the hydroentanglment of one or more nano-denier continuous filament layers, but also to a composite of laminate fabric wherein the fabric may comprise additional fibrous or filmentary materials. Suitable layers may also include films, such as microporous, monolithic, and reticulated films, or supportive members, such as a scrim layer.

An image or pattern may also be imparted into the nano-denier continuous filament layers wherein the fabric is hydroentangled on a foraminous surface or a three-dimensional image transfer device is employed. Additionally, the fabric may be comprised of apertures. The apertures may be of various sizes, extending through the nano-denier fabric in its entirety or partially through the fabric.

In one embodiment of the invention the nano-denier filmentary fabric is a laminate comprised of differing polymeric filaments, such as filaments exhibiting significantly differing bonding temperatures, however the laminate may further be comprised of staple fibers and/or filaments selected from natural or synthetic composition, of homogeneous or mixed fiber length.

Other features and advantages of the present invention will become readily apparent from the following detailed description, the accompanying drawings, and the appended claims.

### DESCRIPTION OF THE DRAWINGS

FIG. 1 is a diagrammatic view of an apparatus for manufacturing the nonwoven fabric embodying the principles of the present invention;

FIG. 2 is a plan view of a diaper in an uncontracted state with portions of the structure being cut-away to more clearly show the construction of the diaper; and

FIG. 3 is a plan view of a surgical gown.

### DETAILED DESCRIPTION OF THE INVENTION

While the present invention is susceptible of embodiment in various forms, there will hereinafter be described, presently preferred embodiments, with the understanding that the present disclosure is to be considered as an exemplification of the invention, and is not intended to limit the invention to the specific embodiments disclosed herein.

In general, continuous filament nonwoven fabric formation involves the practice of the spunbond process. A spunbond process involves supplying a molten polymer, which is then extruded under pressure through a large number of orifices in a plate known as a spinneret or die. The resulting continuous filaments are quenched and drawn by any of a number of methods, such as slot draw systems, attenuator guns, or Godet rolls. The continuous filaments are collected as a loose web upon a moving foraminous surface, such as a wire mesh conveyor belt. When more than one spinneret is used in line for the purpose of forming a multi-layered fabric, the subsequent webs is collected upon the uppermost surface of the previously formed web. The web is then at least temporarily consolidated, usually by means involving heat and pressure, such as by thermal point bonding. Using this means, the web or layers of webs are passed between two hot metal rolls, one of which has an embossed pattern to impart and achieve the desired degree of point bonding, usually on the order of 10 to 40 percent of the overall surface area being so bonded.

Suitable nano-denier continuous filament layers can be formed by either direct spinning of nano-denier filaments or by formation of a multi-component filament that is divided into nano-denier filaments prior to deposition on a substrate layer. U.S. Pat. No. 5,678,379 and No. 6,114,017, both incorporated herein by reference, exemplify direct spinning processes practicable in support of the present invention. Fabrics formed from the direct spinning of nano-fibers are embodied and hereby incorporated by reference, in a previous filing, specifically Ser. No. 60/332,847, to the same assignee. Multi-component filament spinning with integrated division into nano-denier filaments can be practiced in accordance with the teachings of U.S. Pat. No. 5,783,503 and No. 5,970,583, both incorporated herein by reference.

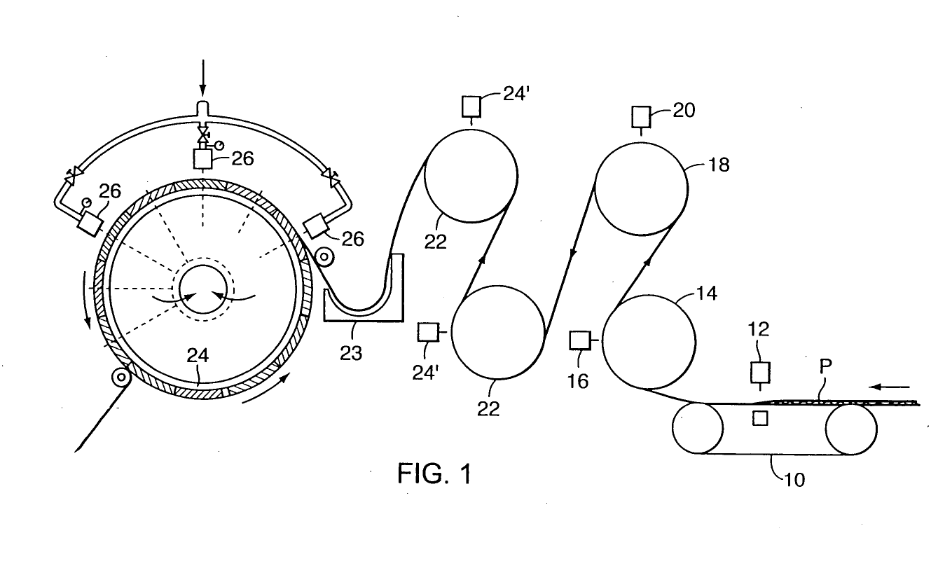

The nonwoven fabric of the invention is comprised of one or more layers of nano-denier continuous filaments that are hydroentanlged. FIG. 1 illustrates a hydroentangling apparatus for forming nonwoven fabrics in accordance with the present invention. The apparatus includes a foraminous-forming surface in the form of belt 10 upon which the precursor web P is positioned for pre-entangling by entangling manifold 12. Pre-entangling of the precursor web, prior to imaging and patterning, is subsequently effected by movement of the web P sequentially over a drum 14 having a foraminous forming surface, with entangling manifold 16 effecting entanglement of the web. Further entanglement of the web is effected on the foraminous forming surface of a drum 18 by entanglement manifold 20, with the web subsequently passed over successive foraminous drums 20, for successive entangling treatment by entangling manifolds 24, 24′.

The entangling apparatus of FIG. 1 further includes an imaging and patterning drum 24 comprising a three-dimensional image transfer device for effecting imaging and patterning of the now-entangled precursor web. The image transfer device includes a moveable imaging surface which moves relative to a plurality of entangling manifolds 26 which act in cooperation with three-dimensional elements defined by the imaging surface of the image transfer device to effect imaging and patterning of the fabric being formed.

In one embodiment of the invention the nano-denier filmentary fabric is a laminate comprised of differing polymeric filaments, such as filaments exhibiting significantly differing bonding temperatures, however the laminate may further be comprised of staple fibers and/or filaments selected from natural or synthetic composition, of homogeneous or mixed fiber length. Suitable natural fibers include, but are not limited to, cotton, wood pulp and viscose rayon. Synthetic fibers, which may be blended in whole or part, include thermoplastic and thermoset polymers. Thermoplastic polymers suitable for blending with thermoplastic resins include polyolefins, polyamides and polyesters. The thermoplastic polymers may be further selected from homopolymers; copolymers, conjugates and other derivatives including those thermoplastic polymers having incorporated melt additives or surface-active agents.

Staple fibers used to form nonwoven fabrics begin in a bundled form as a bale of compressed fibers. In order to decompress the fibers, and render the fibers suitable for integration into a nonwoven fabric, the bale is bulk-fed into a number of fiber openers, such as a garnet, then into a card. The card further frees the fibers by the use of co-rotational and counter-rotational wire combs, then depositing the fibers into a lofty batt. The lofty batt of staple fibers can then optionally be subjected to fiber reorientation, such as by air-randomization and/or cross-lapping, depending upon the ultimate tensile properties of the resulting nonwoven fabric. The fibrous batt is integrated into a nonwoven fabric by application of suitable bonding means, including, but not limited to, use of adhesive binders, thermobonding by calender or through-air oven, and hydroentanglement.

The production of conventional textile fabrics is known to be a complex, multi-step process. The production of staple fiber yarns involves the carding of the fibers to provide feedstock for a roving machine, which twists the bundled fibers into a roving yarn. Alternately, continuous filaments are formed into bundle known as a tow, the tow then serving as a component of the roving yarn. Spinning machines blend multiple roving yarns into yarns that are suitable for the weaving of cloth. A first subset of weaving yarns is transferred to a warp beam, which, in turn, contains the machine direction yarns, which will then feed into a loom. A second subset of weaving yarns supply the weft or fill yarns which are the cross direction threads in a sheet of cloth. Currently, commercial high-speed looms operate at a speed of 1000-1500 picks per minute, whereby each pick is a single yarn. The weaving process produces the final fabric at manufacturing speeds of 60 inches to 200 inches per minute.

The formation of finite thickness films from thermoplastic polymers is a well-known practice. Thermoplastic polymer films can be formed by either dispersion of a quantity of molten polymer into a mold having the dimensions of the desired end product, known as a cast film, or by continuously forcing the molten polymer through a die, known as an extruded film. Extruded thermoplastic polymer films can either be formed such that the film is cooled then wound as a completed material, or dispensed directly onto a hydroentangled nano-denier continuous filament substrate material to form a composite material having performance of both the substrate and the film layers.

Extruded films utilizing the composition of the present invention can be formed in accordance with the following representative direct extrusion film process. Blending and dosing storage comprising at least one hopper loader for thermoplastic polymer chip and, optionally, one for pelletized additive in thermoplastic carrier resin, feed into variable speed augers. The variable speed augers transfer predetermined amounts of polymer chip and additive pellet into a mixing hopper. The mixing hopper contains a mixing propeller to further the homogeneity of the mixture. Basic volumetric systems such as that described are a minimum requirement for accurately blending the additive into the thermoplastic polymer. The polymer chip and additive pellet blend feeds into a multi-zone extruder. Upon mixing and extrusion from the multi-zone extruder, the polymer compound is conveyed via heated polymer piping through a screen changer, wherein breaker plates having different screen meshes are employed to retain solid or semi-molten polymer chips and other macroscopic debris. The mixed polymer is then fed into a melt pump, and then to a combining block. The combining block allows for multiple film layers to be extruded, the film layers being of either the same composition or fed from different systems as described above. The combining block is connected to an extrusion die, which is positioned in an overhead orientation such that molten film extrusion is deposited at a nip between a nip roll and a cast roll.

When a hydroentangled nano-denier continuous filament fabric is to receive a film layer extrusion, the nano-denier fabric may be provided in roll form to a tension-controlled unwinder. The fabric is unwound and moves over the nip roll. The molten film extrusion from the extrusion die is deposited onto the nano-denier continuous filament fabric at the nip point between the nip roll and the cast roll to form a strong and durable substrate layer. The newly formed substrate layer is then removed from the cast roll by a stripper roll and wound onto a new roll.

Breathable films can be combined with the hydroentangled nano-denier continuous filament fabric as well. Monolithic films, as taught in U.S. Pat. No. 6,191,211, and microporous films, as taught in U.S. Pat. No. 6,264,864, both patents herein incorporated by reference, represent the mechanisms of forming such breathable barrier films.

Further, the fabric of the present invention may include a one or more layers of meltblown fabric. The melt blown process is related to the spunbond process for forming a layer of a nonwoven fabric. Again, a molten polymer is extruded under pressure through orifices in a spinneret or die. High velocity air impinges upon and entrains the filaments as they exit the die. The energy of this step is such that the formed filaments are greatly reduced in diameter and are fractured so that microfibers of finite length are produced. This differs from the spunbond process whereby the continuity of the filaments is preserved. The process to form either a single layer or a multiple-layer fabric is continuous, that is, the process steps are uninterrupted from extrusion of the filaments to form the first layer until the bonded web is wound into a roll. Methods for producing these types of fabrics are described in U.S. Pat. No. 4,043,203. The meltblown process, as well as the cross-sectional profile of the spunbond filament or meltblown microfiber, is not a critical limitation to the practice of the present invention.

Incorporating the hydroentangled fabric of nano-denier filaments in a laminate structure enhancements of the fabric are realized. For a given basis weight of the spunbond layer, a finer denier fabric will give a greater number of filaments and a smaller average pore size. The smaller average pore size will result in a more uniform deposition of additional layers onto the nano-denier fabric. A more uniform layer will have fewer weak points in the web at which a failure in barrier performance can occur. The entangled nano-denier filmentary fabric also serves to support additional layers structurally in the compound material. A nano-denier layer provides a smaller average pore size and a larger number of support points for the additional layer, this results in shorter spans of unsupported material. This mechanism embodies the well-known concept that reduction in the average span length results in enhanced structural integrity.

Manufacture of nonwoven compound fabrics embodying the principles of the present invention includes the use of fibers and/or filaments having different composition. Differing thermoplastic polymers can be compounded with the same or different performance improvement additives. Further, fibers and/or filaments may be blended with fibers and/or filaments that have not been modified by the compounding of additives. The profile of the fiber or filament is not a limitation to the applicability of the present invention.

The nonwoven fabric of the present invention may further comprise a mechanical or chemical treatment to modify the surface of the final fabric. Such treatments may comprise spray, dip, or roll applications of wetting agents, surfactants, thermochromics, fluorocarbons, anti-stats, pigments, antimicrobials, flame retardants, binders, or a combination thereof.

A number of end-use articles can benefit from the inclusion of a hydroentnagled nano-fiber filament layer of the present invention, including, but not limited to, hygiene absorbent articles, such as diapers and catamenial products, medical/industrial protective articles, geotextile and agricultural fabrics.

Disposable waste-containment garments are generally described in U.S. Pat. No. 4,573,986, No. 5,843,056, and No. 6,198,018, which are incorporated herein by reference.

An absorbent article incorporating a hydroentangled nano-denier fabric of the present invention is represented by the unitary disposable absorbent article, diaper 20, shown in FIG. 1. As used herein, the term “diaper” refers to an absorbent article generally worn by infants and incontinent persons that is worn about the lower torso of the wearer. It should be understood, however, that the present invention is also applicable to other absorbent articles such as incontinence briefs, incontinence undergarments, diaper holders and liners, feminine hygiene garments, training pants, pull-on garments, and the like.

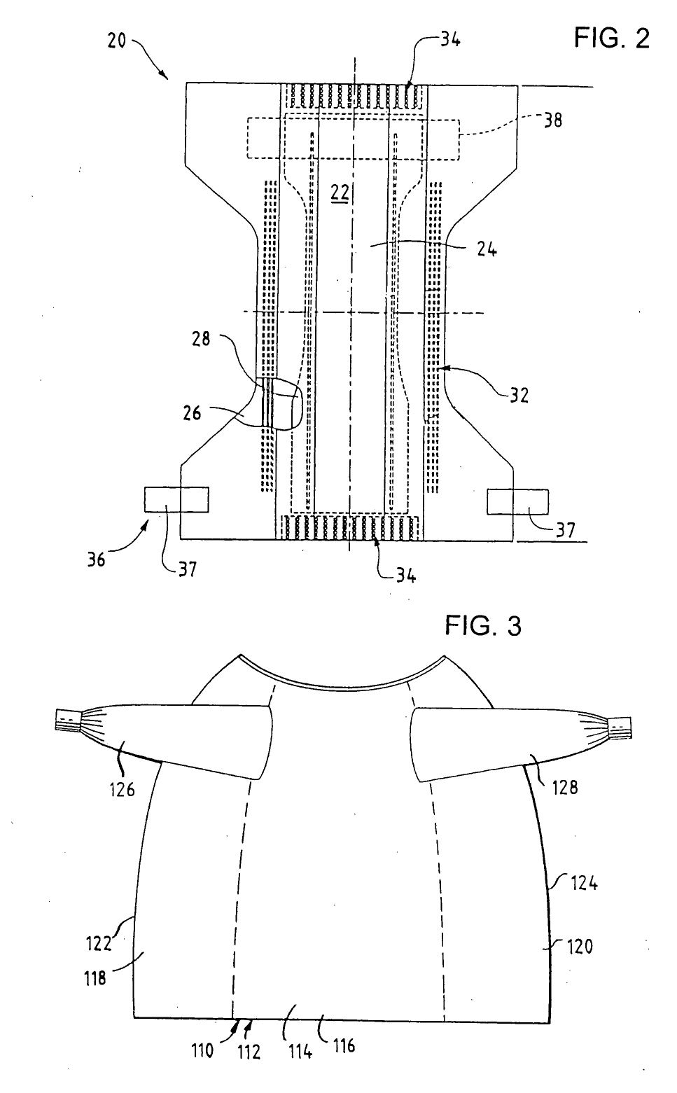

FIG. 2 is a plan view of a diaper 20 in an uncontracted state (i.e., with elastic induced contraction pulled out) with portions of the structure being cut-away to more clearly show the construction of the diaper 20. As shown in FIG. 2, the diaper 20 preferably comprises a containment assembly 22 comprising a liquid pervious topsheet 24; a liquid impervious backsheet 26 joined to the topsheet; and an absorbent core 28 positioned between the topsheet 24 and the backsheet 26. The absorbent core 28 has a pair of opposing longitudinal edges, an inner surface and an outer surface. The diaper can further comprise elastic leg features 32; elastic waist features 34; and a fastening system 36, which preferably comprises a pair of securement members 37 and a landing member 38.

Practical application of a fabric comprising a soft entangled nano-denier layer as described in this invention for backsheet 26 results in a diaper that is lighter in weight while maintaining performance. A lighter weight backsheet material is expected to be more flexible and therefore more conforming to deformation of the overall structure as the diaper is worn.

Catamenial products, such as feminine hygiene pads, are of the same general construction as the aforementioned diaper structure. Again, a topsheet and a backsheet are affixed about a central absorbent core. The overall design of the catamenial product is altered to best conform to the human shape and for absorbing human exudates. Representative prior art to such article fabrication include U.S. Pat. No. 4,029,101, No. 4,184,498, No. 4,195,634, No. 4,408,357 and No. 4,886,513, which are incorporated herein by reference.

Medical and industrial protective products, such as CSR, medical gown, surgical drape and oversuits can benefit significantly from the inclusion of a hydroentangled nano-denier fabric as described in the present invention. Of particular utility in the fabrication of such protective products is the use of lighter weight fabrics with improved barrier to weight ratios, as it is important for the finished product to be as lightweight as possible yet still perform its desired function. Patents generally describing such protective products include U.S. Pat. No. 4,845,779, No. 4,876,746, No. 5,655,374, No. 6,029,274, and No. 6,103,647, which are incorporated herein by reference.

Referring now to FIG. 3, there is shown a disposable garment generally designated 110 comprising a surgical gown 112. The gown 112 comprises a body portion 114, which may be one-piece, having a front panel 116 for covering the front of the wearer, and a pair of back panels 118 and 120 extending from opposed sides of the front panel 116 for covering the back of the wearer. The back panels 118 and 120 have a pair of side edges 122 and 124, respectively, which define an opening on the back of the gown. The gown 112 has a pair of sleeves 126 and 128 secured to the body portion 114 of the gown for the arms of the wearer. In use, the back panels 118 and 120 overlap on the back of the wearer in order to close the back opening of the gown, and suitable belt means (not shown) is utilized to secure the back panels 118 and 120 in the overlapping relationship.

From the foregoing, numerous modifications and variations can be effected without departing from the true spirit and scope of the novel concept of the present invention. It is to be understood that no limitation with respect to the specific embodiments disclosed herein is intended or should be inferred. The disclosure is intended to cover, by the appended claims, all such modifications as fall within the scope of the claims.

1. A method of making a nonwoven fabric comprising the steps of:
a. providing a polymeric melt;
b. extruding said polymeric melt into continuous filaments wherein said filaments are of a diameter less than or equal to 1000 nanometers;
c. collecting said extruded nano-denier continuous filaments on a belt;
d. consolidating said continuous filaments; and
e. hydroentangling said nano-denier filaments so as to form a nonwoven fabric.

2. A method of making a nonwoven fabric comprising the steps of;
a. providing a polymeric melt;
b. extruding said polymeric melt into continuous filaments wherein said filaments are of a diameter less than or equal to 1000 nanometers;
c. collecting said extruded nano-denier continuous filaments on a belt;
d. consolidating said continuous filaments;
e. pre-entangling said nano-denier filaments;
f. advancing said pre-entangled nano-denier filaments onto a foraminous surface; and
g. hydroentangling said filaments on said foraminous surface so as to impart an image into said nonwoven fabric.

3. A method of making a nonwoven fabric comprising the steps of;
a. providing a precursor web comprising nano-denier continuous filaments of a diameter less than or equal to 1000 nanometers;
b. advancing said precursor web onto a foraminous surface; and
c. hydroentangling said filaments on said foraminous surface so as to form said nonwoven fabric.

4. A method of making a nonwoven fabric as in claim 1, wherein said formainous surface is a three-dimensional transfer device.

5. A nonwoven fabric comprising one or more layers of hydroentangled nano-denier continuous filaments wherein said filaments have a diameter of less than or equal to 1000 nanometers.

6. A nonwoven fabric as in claim 5, wherein said fabric is a diaper component.

7. A nonwoven fabric as in claim 5, wherein said fabric is a sanitary napkin component.

8. A nonwoven fabric as in claim 5, wherein said fabric is a disposable garment component.

9. A nonwoven fabric as in claim 5, wherein said fabric is a surgical drape component.
